(19) United States
(12) Patent Application Publication
(10) Pub. No.: US 2012/0086412 A1
(43) Pub. Date: Apr. 12, 2012

(54) Arrangement For Exchanging Power

(76) Inventors: Filippo Chimento, Vasteras (SE); Frans Dijkhuizen, Skultuna (SE); Jean-Philippe Hasler, Vasteras (SE); Falah Hosini, Vasteras (SE); Tomas Jonsson, Vasteras (SE); Peter Lundberg, Vasteras (SE); Mauro Monge, Vasteras (SE); Staffan Norrga, Stockholm (SE); Jan R. Svensson, Vasteras (SE); Fredrik Tinglow, Arboga (SE)

(21) Appl. No.: 13/270,883

(22) Filed: Oct. 11, 2011

Related U.S. Application Data
(63) Continuation of application No. PCT/EP2009/054308, filed on Apr. 9, 2009.

(51) Int. Cl. G05F 1/70

(52) U.S. Cl. 323/207

(57) ABSTRACT

Power exchanging arrangement, in shunt connection, with a three-phase electric power network including on one hand for each said phase a reactive impedance element and a Voltage Source Converter connected in series with said element, and on the other hand a control unit configured to control semiconductor devices of turn-off type of said converter for generating a voltage with a fundamental frequency being equal to the fundamental frequency of the voltage of the respective said phase and by that control a flow of reactive power between said arrangement and the respective phase of said electric power network. Each Voltage Source Converter includes a series connection of switching cells in the form of so-called H-bridges including two switching elements connected in parallel and each having at least two semiconductor assemblies connected in series. Each switching cell further comprises at least one energy storing capacitor connected in parallel with said switching elements.

### CROSS-REFERENCE TO RELATED APPLICATIONS

The present application is a continuation of pending International patent application PCT/EP2009/054308 filed on Apr. 9, 2009 which designates the United States and the content of which is incorporated herein by reference.

### FIELD OF THE INVENTION

The present invention relates to an arrangement for exchanging power in shunt connection, with a three-phase electric power network, said arrangement comprising on one hand for each said phase: a reactive impedance element and a Voltage Source Converter connected in series with said element, and on the other a control unit configured to control semiconductor devices of turn-off type of said Voltage Source Converter for generating a voltage with a fundamental frequency being equal to the fundamental frequency of the voltage of the respective said phase and by that control a flow of reactive power between said arrangement and the respective phase of said electric power network. That is to say, one can mimic the behaviour of a capacitor or reactor.

Compensation of reactive power flows in electric power networks conventionally occurs, inter alia, by connection of reactive impedance elements in the form of inductors and capacitors in shunt connection to the power network. By connecting a semiconductor switch in series with such an inductor the current through the inductor may be controlled and hence also the exchange of reactive power with said network. By connecting a semiconductor switch in series with such a capacitor and control thereof reactive power supplied to the power network may be controlled in steps. Capacitors connected in shunt connection are used primarily in industrial networks to compensate for reactive power consumption in for example large asynchronous motors. Another application of such an arrangement is in connection with loads with a greatly varying reactive power consumption, such as in industrial arc furnaces.

By utilizing a said Voltage Source Converter and controlling this by means of Pulse Width Modulation a rapid control of said exchange of power may be obtained. This takes place by controlling the converter to generate a voltage having a fundamental component essentially coinciding with the voltage of the network with respect to frequency and phase position. By varying the amplitude of this generated voltage the converter may be brought to consume reactive power, if its voltage has a lower amplitude than that of the network, and to generate reactive power, respectively, if its voltage has a higher amplitude than that of the network.

### BACKGROUND OF THE INVENTION

An arrangement according to the introduction is known through U.S. Pat. No. 7,173,349 B2 and two different such arrangements are very schematically illustrated in appended FIGS. 1 and 2. FIG. 1 illustrates a Voltage Source Converter 1′ connected in shunt to an electric power network 2′ through a reactive impedance element in the form of a capacitor 3′. The series connection also comprises a filter inductor 4′ for smoothing out the voltage created by the converter and limit short circuit currents. An advantage of a series connection of the capacitor 3′ with the Voltage Source Converter 1′ is that the converter can be dimensioned for a voltage of 0.33 per unit at a voltage of the power network 2′ of 1.0 per unit. This means that the number of semiconductor devices connected in series in said Voltage Source Converter may be reduced with respect to the case of absence of the capacitor 3′. The capacitor 3′ is then dimensioned for a voltage corresponding to the power network voltage plus the voltage that the converter generates with an opposite phase position in relation to the power network voltage.

FIG. 2 shows another known reactive power compensating arrangement differing from the one according to FIG. 1 by the fact that the reactive impedance element is in this case an inductor 5′, which is then dimensioned for a voltage corresponding to the power network voltage plus the voltage that the converter generates with an opposite phase position in relation to the power network voltage.

### SUMMARY OF THE INVENTION

The object of the present invention is to provide an arrangement of the type defined in the introduction being improved in at least some aspect with respect to such arrangements already known.

This object is according to the invention obtained by providing such an arrangement in which each said Voltage Source Converter comprises a series connection of switching cells in the form of so-called H-bridges comprising two switching elements connected in parallel and each having at least two semiconductor assemblies connected in series and having each a semiconductor device of turn-off type and a rectifying element connected in anti-parallel therewith, each said switching cell further comprising at least one energy storing capacitor connected in parallel with said switching elements, mid points between semiconductor assemblies of each switching element forming terminals of the switching cell for connection to corresponding terminals of adjacent switching cells for forming said series connection of switching cells, and that said control unit is configured to control said semiconductor devices of said semiconductor assemblies of each switching cell and by that each switching cell to deliver a voltage across the terminals thereof being zero, +U or −U, in which U is the voltage across said capacitor, for together with the other switching cells of the Voltage Source Converter deliver a voltage pulse being the sum of the voltages so delivered by each switching cell for generating said voltage for said reactive power flow control.

The utilization of such Voltage Source Converters in the phase series connections results in a number of advantages. Already at a comparatively low number of such switching cells connected in series a comparatively high number of different levels of said voltage pulse delivered by the converter may be obtained, so that a said voltage with fundamental frequency having a shape being very close to a sinusoidal voltage may be obtained already without any smoothing filters. Furthermore, this may be obtained already by means of substantially lower switching frequencies than used in two or three level Voltage Source Converters. Furthermore, this makes it possible to obtain substantially lower losses and also reduces problems of filtering and harmonic currents and radio interferences, so that equipment therefor may be less costly. This altogether results in both a better performance of the arrangement and saving of costs with respect to such arrangements already known.

According to an embodiment of the present invention said reactive impedance element comprises a capacitor making it possible to obtain continuously controllable reactive power generation.

According to another embodiment of the invention said series connection for each phase comprises a filtering inductor configured to smooth said fundamental frequency voltage generated or limit a short circuit current.

According to another embodiment of the invention the series connections of said reactive impedance element and said Voltage Source Converter connected in shunt to the three phases of the electric power network are interconnected by forming a wye-connection. An arrangement of this type connected to a three-phase electric power network will be very efficient in reactive power compensation in the power network.

According to another embodiment of the invention this wye-connection is obtained by having the reactive impedance element of each said phase series connection with one end connected to said phase and the other connected to one end of the series connection of switching cells of the Voltage Source Converter and the other end of this series connection of switching cells of the Voltage Source Converter connected to corresponding ends of the other two Voltage Source Converters.

Alternatively this wye-connection may be obtained by having the Voltage Source Converter of each said phase series connection with one end of said series connection of switching cells connected to said phase and the other end connected to one end of said reactive impedance element and the other end of this reactive impedance element connected to corresponding ends of the reactive impedance elements of the other two phase series connections.

According to another embodiment of the invention the phase series connections of said reactive impedance element and said Voltage Source Converter connected in shunt to the three phases of the electric power network are interconnected by forming a delta-connection. This constitutes another favourable way of connecting an arrangement of this type to a three-phase electric power network, and this type of interconnection of said phase series connections is particularly suited when there is a desire to introduce a transient exchange of active power between the arrangement and the network, such as for reducing flicker, caused in the operation of industrial arc furnaces. This is obtained by the fact that high currents may by such a connection be delivered from the arrangement to the network.

According to another embodiment of the invention the delta-connection is formed by having said reactive impedance element of each said phase series connection connected with one end to said phase and with the other to a first end of the series connection of switching cells of the said Voltage Source Converter, and a second end of the series connection of switching cells of each Voltage Source Converter is connected to a said first end of a Voltage Source Converter of one of the other two phase series connections.

Another advantage of the above arrangements having said phase series connections interconnected by forming a wye-connection or delta-connection to a three-phase electric power network when the arrangement comprises a reactive impedance element in the form of a capacitor is that the capacitor can block dc current and allows asymmetrical grounding.

According to another embodiment of the invention the number of switching cells of said series connection of switching cells in each said Voltage Source Converter is practically proportional to the intended supply voltage on said network, and for instance 4-20 or 8-15. Although a cost saving of an arrangement of this type is obtained by the reduced number of switching cells connected in series required, the use of a converter of this type is particularly interesting when the number of switching cells in said series connection is rather high resulting in a high number of possible levels of the voltage pulses delivered by the converter.

According to another embodiment of the invention said semi-conductor devices of said semiconductor assemblies are IGBTs (Insulated Gate Bipolar Transistor), IGCTs (Integrated Gate Commutated Thyristor) or GTOs (Gate Turn-Off thyristor). These are suitable semiconductor devices for such converters, although other semiconductor devices of turn-off type are also conceivable.

According to another embodiment of the invention said Voltage Source Converters have a capacity together with said reactive impedance element connected in series therewith to generate a said fundamental frequency voltage with an amplitude of 10 kV-300 kV, preferably 30 kV-200 kV. Such an arrangement will be suitable for exchanging power with for instance a high-voltage transmission line typically carrying a voltage of 132-500 kV, with or without an interfacing transformer to the network, or a power network feeding an industrial arc furnace with a fundamental voltage of 36 kV.

The invention also relates to a use of an arrangement according to the invention for exchanging power with a three-phase electric power network, in which preferable such uses are for exchanging power with a power network feeding an industrial arc furnace and with a three-phase electric power network in the form of a high-voltage transmission line.

Further advantages as well as advantageous features of the invention will appear from the following description.

### BRIEF DESCRIPTION OF THE DRAWINGS

With reference to the appended drawings, below follows a specific description of embodiments of the invention cited as examples. In the drawings:

FIGS. 1 and 2 are very simplified views showing the general structure of two different types of arrangements of the present invention,

FIG. 3 is a simplified view illustrating a part of a Voltage Source Converter in the form of two switching cells connected in series in an arrangement according to the invention,

FIG. 4 is a schematic view illustrating an arrangement according to a first embodiment of the present invention connected to a three-phase electric power network, and

FIG. 5 is a view similar to FIG. 4 for an arrangement according to a second embodiment of the invention.

### DETAILED DESCRIPTION OF THE INVENTION

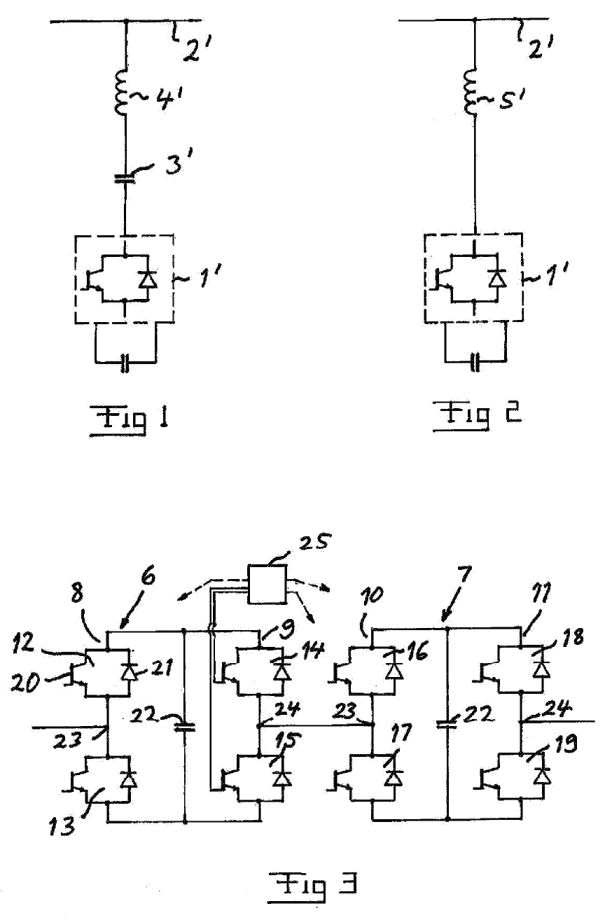

FIG. 3 schematically illustrates the general structure of a Voltage Source Converter in an arrangement for exchanging power, in shunt connection, with a three-phase electric power network 2 of the type shown in FIG. 1. This converter comprises a series connection of switching cells 6, 7, of which here only two are shown, but the number thereof may be any conceivable. Each switching cell has the form of a so-called H-bridge comprising two switching elements 8-11 connected in parallel and each having at least two semiconductor assemblies 12-19 connected in series and having each a semiconductor device 20 of turn-off type, such as for instance an IGBT, and a rectifying element 21, such as a free-wheeling diode, connected in anti-parallel therewith. Each switching cell further comprises at least one energy storing capacitor 22 having a voltage across the terminals thereof of U and connected in parallel with the switching elements. Mid points 23, 24 between semiconductor assemblies of each switching element form terminals of the switching cell for connection to corresponding terminals of adjacent switching cells for forming a series connection of switching cells. Thus, the converter is formed by a so-called chain-link of H-bridge cells.

The arrangement comprises a control unit 25 configured to control said semiconductor devices of said semiconductor assemblies of each switching cell and by that each switching cell to deliver a voltage across the terminals 23, 24 thereof being zero, such as when the switching assemblies 12 and 14 or 13 and 15 are conducting, +U when the switching assemblies 13 and 14 are conducting or −U when the switching assemblies 12 and 15 are conducting. This voltage will then be added to corresponding voltages of the other switching cells in the series connection of the Voltage Source Converter for delivering a voltage pulse being the sum of these voltages. In the case of for instance ten switching cells connected in series in such a Voltage Source Converter 21 different levels of such a voltage pulse may be obtained.

It is pointed out that the semiconductor device 20 and the diode 21 shown in FIG. 3 may stand for a number of such devices and diodes connected in series for obtaining a voltage handling capability aimed at.

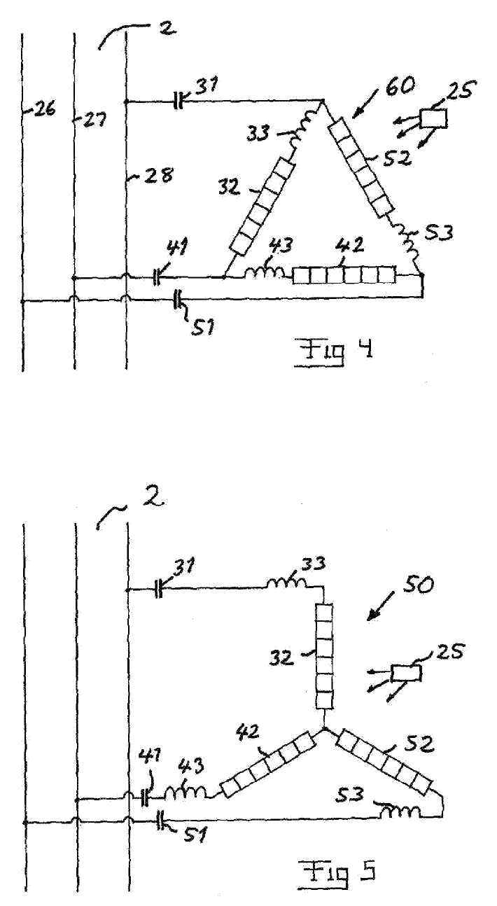

FIG. 4 illustrates schematically an arrangement according to a first embodiment of the invention connected to a three-phase electric power network 2 having three phase lines or phases 26, 27, 28. The arrangement comprises for each phase a reactive impedance element in the form of a capacitor 31, 41, 51 connected in series with a Voltage Source Converter 32, 42 and 52, respectively. Each Voltage Source Converter is formed by a series connection of switching cells of the type shown in FIG. 3 and illustrated by six consecutive boxes. Furthermore, an inductor 33, 43 and 53 for filtering and short-circuit current limitation is provided in each said phase series connection.

These phase series connections connected in shunt to the three phases of the electric power network are in this embodiment interconnected by forming a delta-connection 60, which is obtained by having a capacitor of each said phase series connection connected with one end to said phase and with the other to a first end of the series connection of the switching cells of said Voltage Source Converter, whereas a second end of the series connection of switching cells of each Voltage Source Converter is connected to a said first end of a Voltage Source Converter of one of the other two phase series connections. Such a delta-connection of the Voltage Source Converters results in a possibility to vary the current delivered by such an arrangement within a wide range making this embodiment particularly well suited to be used for exchanging power with an electric power network feeding an industrial arc furnace for reducing flicker as the delta connection reveals a higher current capability. It is then namely advantageous to in addition to compensating the voltage variations by means of exchange of reactive power with the power network also to introduce a transient exchange of active power through such an arrangement.

FIG. 5 illustrates an arrangement according to a second embodiment of the invention differing from the one according to FIG. 4 by the way of interconnecting the Voltage Source Converters of the different phase series connections. These are in this embodiment interconnected by forming a wye-connection 50. This is obtained by having the capacitors 31, 41, 51 of each said phase series connection with one end connected to the phase 28, 27, 26 and the other connected to one end of the series connection of switching cells of the Voltage Source Converter 32, 42, 52 and the other end of this series connection of switching cells of the Voltage Source Converter connected to corresponding ends of the other two Voltage Source Converters. This arrangement is particularly suitable for compensation of reactive power in a high-voltage transmission line, since it results in a possibility to vary voltage amplitudes within a wide range.

Furthermore, by control of the voltage of the Voltage Source Converters in the arrangements according to the invention to an arbitrary phase position in relation to the voltage of the electric power network both reactive and active power may be exchanged with the network. Moreover, different possibilities to exchange power with an electric power network through an arrangement of the inventional type are thoroughly explained in U.S. Pat. No. 7,173,349 B2 and the corresponding control schemes of the arrangements disclosed there are also possible for the arrangements according to the invention. The disclosure of U.S. Pat. No. 7,173,349 B2 is for that sake included herein by reference thereto.

The invention is of course not in any way restricted to the embodiments described above, but many possibilities to modifications thereof will be apparent to a person with skill in the art without departing from the scope of the invention as defined in the appended claims.

The arrangement may for example have a transformer connecting the respective Voltage Source Converter to the reactive impedance element associated therewith.

1. An arrangement for exchanging power, in shunt connection, with a three-phase electric power network, said arrangement comprising on one hand for each said phase:
a reactive impedance element and
a Voltage Source Converter connected in series with said element, and on the other
a control unit configured to control semiconductor devices of turn-off type of said Voltage Source Converter for generating a voltage with a fundamental frequency being equal to the fundamental frequency of the voltage of the respective said phase and by that control a flow of reactive power between said arrangement and the respective phase of said electric power network,
each said Voltage Source Converter comprising a series connection of switching cells in the form of so-called H-bridges comprising two switching elements connected in parallel and each having at least two semiconductor assemblies connected in series and having each a semiconductor device of turn-off type and a rectifying element connected in anti-parallel therewith, each said switching cell further comprising at least one energy storing capacitor connected in parallel with said switching elements, mid points between semiconductor assemblies of each switching element forming terminals of the switching cell for connection to corresponding terminals of adjacent switching cells for forming said series connection of switching cells,
and said control unit being configured to control said semiconductor devices of said semiconductor assemblies of each switching cell and by that each switching cell to deliver a voltage across the terminals thereof being zero, +U or −U, in which U is the voltage across said capacitor, for together with the other switching cells of the Voltage Source Converter deliver a voltage pulse being the sum of the voltages so delivered by each switching cell for generating said voltage for said reactive power flow control, characterized in that said reactive impedance element comprises a capacitor.

2. The arrangement according to claim 1, characterized in that said series connection for each said phase comprises a filtering inductor configured to smooth said fundamental frequency voltage generated or limit a short circuit current.

3. The arrangement according to claim 1, characterized in that the phase series connections of said reactive impedance element and said Voltage Source Converter connected in shunt to the three phases of the electric power network are interconnected by forming a wye-connection.

4. The arrangement according to claim 3, characterized in that this wye-connection is obtained by having the reactive impedance element of each said phase series connection with one end connected to said phase and the other connected to one end of the series connection of switching cells of the Voltage Source Converter and the other end of this series connection of switching cells of the Voltage Source Converter connected to corresponding ends of the other two Voltage Source Converters.

5. The arrangement according to claim 3, characterized in that this wye-connection is obtained by having the Voltage Source Converter of each said phase series connection with one end of said series connection of switching cells connected to said phase and the other end connected to one end of said reactive impedance element and the other end of this reactive impedance element connected to corresponding ends of the reactive impedance elements of the other two phase series connections.

6. The arrangement according claim 1, characterized in that the phase series connections of said reactive impedance element and said Voltage Source Converter connected in shunt to the three phases of the electric power network are interconnected by forming a delta-connection.

7. The arrangement according to claim 6, characterized in that the delta-connection is formed by having said reactive impedance element of each said phase series connection connected with one end to said phase and with the other to a first end of the series connection of switching cells of said Voltage Source Converter, and that a second end of the series connection of switching cells of each Voltage Source Converter is connected to a said first end of a Voltage Source Converter of one of the other two phase series connections.

8. The arrangement according to claim 1, characterized in that the number of switching cells of said series connection of switching cells in each said Voltage Source Converter is practically proportional to the intended supply voltage on said network, and for instance 4-20 or 8-15.

9. The arrangement according to claim 1, characterized in that said semiconductor devices, of said semiconductor assemblies are IGBTs (Insulated Gate Bipolar Transistor), IGCTs (Integrated Gate Commutated Thyristor) or GTOs (Gate Turn-Off thyristor).

10. The arrangement according to claim 1, characterized in that said Voltage Source Converters have a capacity to together with said reactive impedance element connected in series therewith generate a said fundamental frequency voltage with an amplitude of 10 kV-300 kV, preferably 30 kV-200 kV.

11. A use of an arrangement according to claim 1 for exchanging power with a three-phase electric power network.

12. The use according to claim 11, in which said power network is feeding an industrial arc furnace and typically carries a voltage of 36 kV.

13. The use according to claim 11 for exchanging power with a three-phase electric power network in the form of a high-voltage transmission line, which typically carries a voltage of 132-500 kV with or without interfacing transformer to the network.
